(19) United States
(12) Patent Application Publication
(10) Pub. No.: US 2025/0254493 A1
(43) Pub. Date: Aug. 7, 2025

(54) BLUETOOTH TAG TIMING AND TRACKING METHODS FOR MASS PARTICIPATORY SPORTING EVENTS

(71) Applicant: ACTIVE TRACK, LLC, Portland, OR (US)

(72) Inventor: Arash Kia, Portland, OR (US)

(21) Appl. No.: 19/016,617

(22) Filed: Jan. 10, 2025

Related U.S. Application Data
(63) Continuation-in-part of application No. 17/971,983, filed on Oct. 24, 2022, now Pat. No. 12,322,216.
Application No. 17/971,983 is a continuation-in-part of application No. 17/107,529, filed on Nov. 30, 2020, now Pat. No. 11,501,582.
(63) Continuation-in-part of application No. 17/841,507, filed on Jun. 15, 2022.
(60) Provisional application No. 63/620,157, filed on Jan. 11, 2024.
(60) Provisional application No. 62/942,156, filed on Dec. 1, 2019.
(60) Provisional application No. 63/210,922, filed on Jun. 15, 2021.
(60) Provisional application No. 63/299,340, filed on Jan. 13, 2022.
(60) Provisional application No. 63/678,494, filed on Aug. 1, 2024.

(51) Int. Cl. H04W 4/029; H04W 4/80

(52) U.S. Cl. CPC H04W 4/029; H04W 4/80

(57) ABSTRACT

One of the main services provided by the participatory athletic events (i.e., marathons and triathlons), is an event completion time. Today's timing systems generally use a form of RFID to assign a unique ID to each participant and use the unique RFID signal at each checkpoint to ID and time the participants. Many of these RFID devices are not configurable after manufacturing. Their output power level or the transmission rate could not be changed. In our application, we introduce the use of Bluetooth devices to ID the participants, control the transmission power and the transmission interval of the signal sent out by Bluetooth devices. We introduce a system that is significantly lighter to carry, easier to deploy, and uses lower operating voltages than a traditional RFID system commonly used in participatory athletic events.

### PRIORITY CLAIM

This application claims priority to Non-Provisional application Ser. No. 17/971,983, filed Oct. 24, 2022, which is a Continuation of Ser. No. 17/107,529, filed Nov. 30, 2020, which claims priority to Provisional Application No. 62/942,156, filed Dec. 1, 2019. This application claims priority to Non-Provisional application Ser. No. 17/841,507, filed Jun. 15, 2022, which claims priority to Provisional Application No. 63/210,922, filed Jun. 15, 2021 and Provisional Application 63/299,340, filed Jan. 13, 2022; This application claims priority to Provisional Application No. 63/678,494, filed Aug. 1, 2024; This application claims priority to Provisional Application No. 63/620,157, filed Jan. 11, 2024; the contents of which are hereby incorporated by reference in their entirety as if fully set forth herein.

### COPYRIGHT NOTICE

This disclosure is protected under United States and/or International Copyright Laws. ©2022. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

In participatory endurance athletic events (i.e., marathons and triathlons) that are open to the public, the participants sign up to run on a specific course and receive a completion time. The event organizers provide a start and finish time for each participant. The participants are timed using Radio Frequency ID (RFID) tags when they cross a timing line. Today, the majority of the events provide a finish time and little else for the participants. The inventions on this application are tailored towards these types of participatory events. Our inventions will cover claims on products developed to enhance the experience of the participants. We enhance the experience of the participants by sending data out from the course that could be used to time, track, and position the participants through the use of Bluetooth devices. The same Bluetooth device is used to perform all of these services. This device transmits a programmable ID assigned to the Bluetooth device at an interval that could also be programmed inside the device. The output power level of the Bluetooth device could also be changed during operation, which would impact the transmission range of the device. A new feature of the developed system is the ability to transmit data from remote regions that do not have cell coverage. ActiveTrack's communication devices, using available public frequency bands, will be able to transmit data from a course for tens of miles to a hotspot when necessary. After the course data arrives to the cloud, the position of the participants could be mapped. Whether cell coverage or our own transmission protocols are used to relay the data out to the cloud, our system will map the participant's location.

### BRIEF DESCRIPTION OF THE DRAWING FIGURES

FIG. 1 illustrates a top perspective view of an embodiment of the system with gateways picking up the BLE ID and transmitting the data to the host on the cloud;

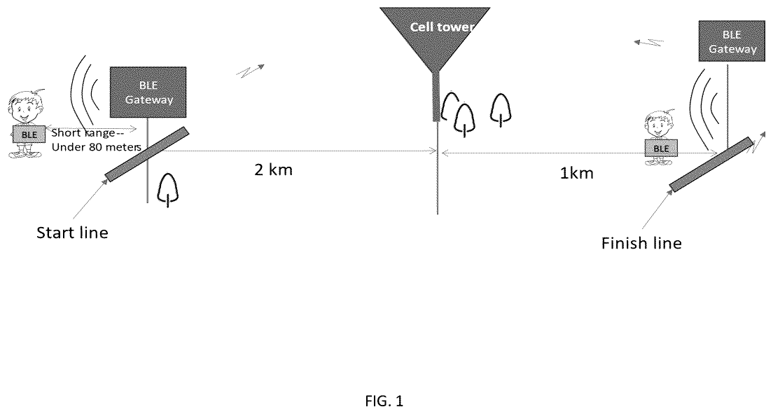

FIG. 2 is a front plan view of an embodiment of the system when there is no cell connectivity or a hot spot where the BLE tag is detected;

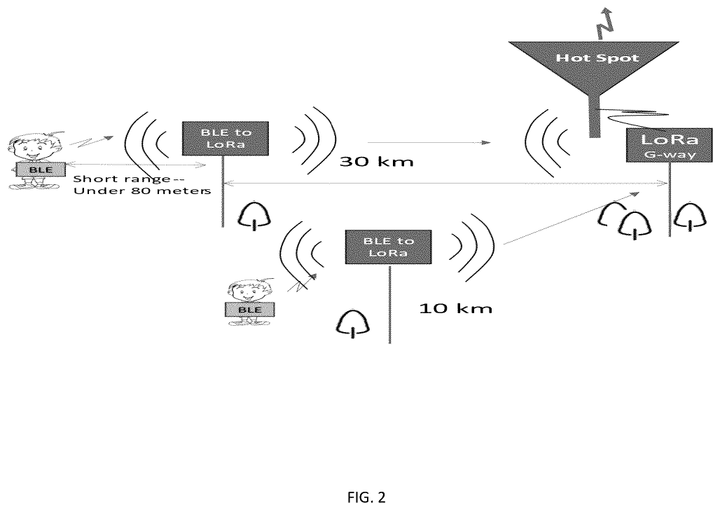

### DETAILED DESCRIPTION

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Participatory athletic events draw people who pay and sign up to perform in an event. There events are open to all people who are willing to pay the entry fee. One of the services provided for the participants is their event completion time. Today's participatory event timing systems, often use RFID systems with passive RFID tags and ground antennas that powerup these passive RFID tags and capture their ID. In our invention, we identify the participants by placing a Bluetooth (BLE) tag on a slap band or another form of a wristband. This BLE tag broadcasts its ID which is picked up by a gateway or scanner capable of “seeing” Bluetooth signals. The gateways capable of scanning for Bluetooth devices are placed at checkpoints marking points of interest on a course (i.e. start line/finish lines). Crossing times are determined when the signal strength of the transmission from the Bluetooth device is at its maximum relative to the gateway placed on the course.

The signal strength is expected to reach maximum strength when the tag is at the closest proximity to the checkpoint where the scanning gateway is placed. The tags are calibrated to have a known signal strength at a distance of 1 meter separation from the gateway.

The position of any and all race assets tagged with a Bluetooth transmitter, including those on the participants, could be mapped using Google® maps.

The tags could be programmed to transmit at certain power and certain transmission rates. ActiveTrack sets the transmission power at 0 decibels and the transmission rate at 100 msec. At this level of transmission, the Bluetooth tag batteries would be expected to operate for over 1.5 years when used for 2 races per week at about 5 hours per use.

The gateway is equipped with a sim card and can deliver the scanned data from the field to the cloud.

In case of no cell service, two alternative solutions could be implemented on the course. The first would offer a local computing device that would be used to perform analytics on the captured data and publish the fastest to slowest crossing times at a checkpoint. The downside of local processing is that the positioning functions will only be available when the data is available on the cloud.

A second method based on Long Range (LoRa) wireless communication could be used to provide connectivity between a scanner on the field and a detector tens of miles away.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. Bluetooth devices assigned to each participant will identify and time the participants of an athletic event.

2. The same Bluetooth devices will be used to track and position the participants of an athletic event.

3. Use of the (Long Range) LoRa communication technology to transmit data from a remote course where cell service is either not available or is not strong enough to deliver the data out to the cloud.
